(19) United States
(12) Patent Application Publication
(10) Pub. No.: US 2007/0191666 A1
(43) Pub. Date: Aug. 16, 2007

(54) Method of cleaning up lead-contaminated soil

(75) Inventors: Izumi Watanabe, Tokyo (JP); Ryoichi Yamada, Tokyo (JP); Takeshi Uchida, Tokyo (JP)

Correspondence Address: JORDAN AND HAMBURG LLP, 122 EAST 42ND STREET, SUITE 4000, NEW YORK, NY, 10168, US

(73) Assignee: SATO KOGYO CO., LTD., Toyama (JP)

(21) Appl. No.: 10/593,162

(22) PCT Filed: Mar. 10, 2005
(86) PCT No.: PCT/JP05/04179

§ 371 Date: Oct. 12, 2006

(30) Foreign Application Priority Data
Mar. 17, 2004 (JP) 2004-075765

(51) Int. Cl. C01G 17/00; B09B 3/00

(52) U.S. Cl. 588/249; 588/412; 588/261; 502/401; 423/89

(57) ABSTRACT

[PROBLEMS TO BE SOLVED] To effectively clean up lead-contaminated soil through phytoremediation aiming at decontamination with the use of a plant. [MEANS FOR SOLVING PROBLEMS] A plant species which is rich in oxalic acid is grown in soil contaminated with lead and/or a compound thereof by sowing a seed or transplanting a seedling. After the plant species rich in oxalic acid is allowed to absorb and accumulate lead and/or the compound, the plant is harvested and removed. As the plant rich in oxalic acid, any of plants belonging to the family Polygonaceae, Oxalidaceae, Chenopodiaceae, Araceae, Begoniaceae and Musaceae or a combination thereof is used. [SELECTED DRAWING] Non

### TECHNICAL FIELD

The present invention relates to a method of cleaning up lead-contaminated soil aiming at cleaning up soil contaminated particularly with lead among methods (phytoremediation) aiming at cleaning up soil contaminated with heavy metals with the use of a plant.

### BACKGROUND ART

In recent years, from the viewpoint of problems on the economic and environmental burden and the like, a method of trying to remove heavy metals in the environment by growing a plant that absorbs and accumulates heavy metals in soil contaminated with heavy metals and harvesting and removing the plant (phytoremediation) has attracted attention as a novel technique for cleaning up soil contamination.

For example, a variety of phytoremediations described in the following Patent documents have been proposed.

In the following Patent document 1, a decontamination method is proposed in which a plant belonging to the genus Malvaceae Hibiscus is grown on a medium contaminated with a heavy metal and after allowing it to absorb and accumulate the heavy metal, the plant is harvested.

In the following Patent document 2, a decontamination method is proposed in which a plant belonging to the genus Chenopodiaceae Chenopodium, Chenopodiaceae Spinacia, or Chenopodiaceae Crotalaria is grown on a medium contaminated with a heavy metal and after allowing it to absorb and accumulate the heavy metal, the plant is harvested.

In the following Patent document 3, a decontamination method is proposed in which a plant belonging to the genus Malvaceae Abelmoschus is grown on a medium contaminated with a heavy metal and after allowing it to absorb and accumulate the heavy metal, the plant is harvested.

In the following Patent document 4, a method of cleaning up soil by allowing a plant to absorb a heavy metal in soil and to accumulate the heavy metal in the plant body, in which L-glutamate diacetate is allowed to coexist in the soil is proposed.

In the following Patent document 5, a method of cleaning up heavy metal-containing soil in which at least two or more types of plants with an ability to absorb a heavy metal and a different growth characteristic are planted in combination in heavy metal-containing soil is proposed.

Further, in the following Patent document 6, a method of cleaning up contaminated soil in which heavy metals in soil are removed by growing a glycoside compound type plant (Aucuba, Polygonaceae, Fagopyrum or Swertia) or a plant of another compound type (Phragmites, fern, Athyrium or Miscanthus) in soil contaminated with metals such as cadmium and harvesting and removing the plant from the soil after the plant has grown to a certain degree is proposed.
Patent document 1: JP-A-2002-331281
Patent document 2: JP-A-2002-331282
Patent document 3: JP-A-2002-336837
Patent document 4: JP-A-2003-275741
Patent document 5: JP-A-2001-276801
Patent document 6: JP-A-57-190
Non-patent document 7: EDTA enhanced heavy metal phytoextraction: metal accumulation, leaching and toxicity (Plant and Soil 235: 105-114, 2001
Non-patent document 8: Enhancement of phytoextraction of Zn, Cd and Cu from Calcareous Soil: The Use of NTA and Sulfur Amendments (Environmental Science & Technology 34, 1778-1783, 2000)

### DISCLOSURE OF THE INVENTION

### Problems that the Invention is to Solve

Incidentally, in recent years, lead contamination at firing ranges has become a social problem. The lead component of scattered lead pellets is eluted and causes soil contamination and the problem in which the lead component flows into rivers and streams and causes contamination of water for daily life has become more serious. Some firing ranges have been temporarily closed one after another for the removal of lead.

As a method of removing lead, for example, a method in which a contaminated soil part is excavated and landfill is carried out with additional soil (landfill method with additional soil), a method in which a lead component is solidified by solidifying ground with a cement solidifier (ground improvement method), bioremediation using a microorganism or the like has been adopted.

However, in the case of the landfill method with additional soil, a lot of time and labor are needed for the excavation and landfill. In the case of the ground improvement method, there were problems in that soil environment was significantly changed and enormous cost and time were required for the improvement work, and the like. Further, in the case of the bioremediation using a microorganism, there were problems in that the control of microorganism was difficult and effectiveness on lead removal was low, and the like.

On the other hand, in the case of the phytoremediation aiming at cleaning up soil contaminated with heavy metals with the use of a plant, although it is considered promising due to a reason that economic and environmental burden is low and the like, each of the phytoremediations disclosed in the above Patent documents 1 to 6 mainly targets heavy metals such as cadmium and zinc and does not particularly target lead, and there was a problem in that their removal effect against lead was small. For example, as for a plant species to be used for the decontamination of heavy metals, plants belonging to the family Gramineae, Asteraceae, Leguminosae and the like are common, however lead absorption or accumulation is not observed in these plant species.

Lead has a large atomic weight among heavy metal elements, and is particularly a heavy element among heavy metals, and has a chemical property that it is very slightly soluble in water under normal soil environmental conditions (physical/chemical conditions). Salts easily soluble in water among lead compounds are only lead nitrate (Pb(NO₃)₂) and lead acetate (Pb(CH₃COO)₂). In the decontamination of a heavy metal with the use of a plant, it is important to firstly convert the heavy metal into a soluble form and allow it to be absorbed from the roots. However, when lead is targeted, absorption from the plant roots is difficult due to the chemical property as described above, and a plant which absorbs lead selectively and effectively has not been identified.

On the other hand, in order for a plant to absorb and accumulate heavy metals effectively, the mixing of an agent such as EDTA or citric acid in soil as a solubilization promoter is also carried out (see the above Non-patent documents 7 and 8). However, if these agents are artificially mixed in the soil, because the biodegradability of EDTA in soil is slow, there are concerns that these agents may possibly remain in the soil for a long period of time, and moreover, they strongly bind to other cations and may possibly degrade the inherent function of soil or change its property. In addition, because the amount of eluting lead is increased by several tens of times by spreading a chelating agent, there was a problem in that lead contamination may be diffused contrary to intention if wastewater treatment was carried out inappropriately.

Accordingly, the main object of the present invention cleaning up lead-contaminated soil according to claim 1, wherein as the plant rich in oxalic acid, any of plants belonging to the family Polygonaceae, Oxalidaceae, Chenopodiaceae, Araceae, Begoniaceae and Musaceae or a combination thereof is used is provided.

### Advantage of the Invention

As described in detail above, according to the present invention, phytoremediation is carried out with the use of a plant species rich in oxalic acid, therefore, a lead component in soil is effectively absorbed from the roots and it becomes possible to remove the lead component from the soil.

### Best Mode for Carrying Out the Invention

Hereinafter, a mode for carrying out the present invention will be described in detail.

The present method of cleaning up lead-contaminated soil is a method in which a plant species rich in oxalic acid (hereinafter referred to as a oxalic acid-rich plant) is grown in soil contaminated with lead and/or a compound thereof by sowing a seed or transplanting a seedling, and after the plant species rich in oxalic acid is allowed to absorb and accumulate lead and/or the compound, the plant is harvested and removed.

As the oxalic acid-rich plant, any one of plants belonging to the family Polygonaceae represented by Persicaria longiseta, Polygonum cuspidatum and Rumex japonicus, plants belonging to the family Oxalidaceae represented by Oxalis corniculata, plants belonging to the family Chenopodiaceae represented by Chenopodium album and Spinacia oleracea, plants belonging to the family Araceae represented by Colocasia esculenta and Alocasia odora, plants belonging to the family Begoniaceae represented by Begonia semperflorens, Begonia spp., Begonia grandis and Begonia Semperflorens, and plants belonging to the family Musaceae represented by Strelitzia, Heliconia, Musa basjoo, Musa coccinea and Ravenala madagascariensis, or a combination thereof may be used. The plants belonging to the family Oxalidaceae and Polygonaceae contain approximately 10% or more of soluble potassium oxalate (potassium hydrogen oxalate, KHC₂O₄) in the whole plant body. Further, the plants belonging to the family Chenopodiaceae contain 10% or more of soluble oxalic acid (sodium oxalate (CO₂Na)₂).

Soil to be applied is soil contaminated with lead and/or a compound thereof, more specifically a firing range and the like.

It is generally known that oxalic acid or various organic acids (such as citric acid and malic acid) are secreted from plant roots and any of these organic acids contains a carboxyl group in the molecular structure.

In the present invention, lead and/or a compound thereof are/is converted into a water-soluble form by oxalic acid secreted from the oxalic acid-rich plant, and by being absorbed from the plant roots and accumulated in the plant body, lead and/or a compound thereof in the soil are/is removed from the soil.

The above-mentioned oxalic acid-rich plant is grown for a period suitable for absorbing lead and/or a compound thereof, and an aerial part of the plant including leaves and shoots or subterranean roots including roots is harvested by an appropriate method. The harvesting method is arbitrary, for example, a harvesting method in which only the aerial part is harvested and harvesting is repeated after it grows again, a method in which the aerial part and the subterranean roots of the plant are harvested together or the like is used.

After the harvested plant is treated by such as burning, grinding or melting treatment, lead can be recovered or the burned ash can be detoxified by solidification and encapsulation thereof in such as concrete or resin.

### EXAMPLE

A temporarily closed firing range was used and a field in which the content of lead in soil was relatively constant was selected. As plant species used in the decontamination method according to the present invention, 5 species, i.e., Persicaria longiseta (belonging to the family Polygonaceae), Polygonum cuspidatum (belonging to the family Polygonaceae), Rumex japonicus (belonging to the family Polygonaceae), Oxalis corniculata (belonging to the family Oxalidaceae) and Chenopodium album (belonging to the family Chenopodiaceae) were grown and a group of plants shown in the following Table 1 were grown as Comparative example. The aerial parts and the subterranean roots were harvested together after 6 months and their lead contents were examined.

TABLE 1
[Example]
(mg/kg)

| | | Polygonum | Rumex | Oxalis | Chenopodium |
|---|---|---|---|---|---|
| | Persicaria longiseta | cuspidatum | japonicus | corniculata | album |
| Lead content | 600 | 580 | 220 | 650 | 1780 |

[Comparative example]
(mg/kg)

| | | | Leguminosae | | | | | |
|---|---|---|---|---|---|---|---|---|
| Asteraceae | | | | | Indigofera | Gramineae | | |
| Artemisia | Aster | Conysa | Kummerowia | Pueraria | pseudo- | Eriochloa | Miscanthus | Poa |
| princeps | ageratoides | sumatrensis | striata | lobata | tinctoria | villosa | sinensis | acroleuca |
| 3.60 | 1.90 | 2.25 | 2.32 | 8.92 | 6.05 | 3.00 | 2.73 | 1.46 |

From the results shown in the above Table 1, it was found that in the case of oxalic acid-rich plant species used in the present invention, the ability of absorbing and accumulating lead is significantly higher compared with other plants.

1. A method of cleaning up lead-contaminated soil, comprising growing at least one plant of a plant species which is rich in oxalic acid in soil contaminated with lead and/or a lead compound by sowing a seed or transplanting a seedling, and after allowing the plant rich in oxalic acid to absorb and accumulate lead and/or the lead compound, harvesting and removing the plant.

2. The method of cleaning up lead-contaminated soil according to claim 1, wherein said at least one plant comprises at least one plant of the Polygonaceae, Oxalidaceae, Chenopodiaceae, Araceae, Begoniaceae and/or Musaceae families.
